(19) United States
(12) Patent Application Publication
(10) Pub. No.: US 2004/0035861 A1
(43) Pub. Date: Feb. 26, 2004

(54) High-power control circuit of microwave oven

(75) Inventor: Sung-Ho Lee, Hwasung-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/326,982

(22) Filed: Dec. 24, 2002

(30) Foreign Application Priority Data
Aug. 24, 2002 (KR) 2002-50277

(51) Int. Cl. H05B 6/66

(52) U.S. Cl. 219/715

(57) ABSTRACT

A high-power control circuit of a microwave oven which is capable of making a voltage and current of a high-voltage transformer in the microwave oven to be in phase to improve a power-factor in the high-voltage transformer, thereby raising output power of the oven to a high level. The high-power control circuit comprises a power-factor compensator compensating a degradation in power-factor resulting from a voltage/current phase difference in the high-voltage transformer. The output power of the microwave oven is raised to a high level by improving the power-factor based on the voltage/current phase difference in the high-voltage transformer.

### CROSS-REFERENCE TO RELATED APPLICATIONS

This application claims the benefit of Korean Application No. 2002-50277, filed Aug. 24, 2002, in the Korean Intellectual Property Office, the disclosure of which is incorporated herein by reference.

### BACKGROUND OF THE INVENTION

1. Field of the Invention

The present invention relates to microwave ovens, and more particularly, to a high-power control circuit of a microwave oven improving a power-factor of power supplied to the microwave to enhance output power efficiency of a magnetron.

2. Description of the Related Art

Microwave ovens are generally adapted to perform cooking based on a super-high frequency, in a different manner from cooking equipment of an external heating type based on thermal conduction and thermal radiation. Such a conventional microwave oven comprises a super-high frequency oscillation tube, or a magnetron, generating a super-high frequency of 2,450 MHz in response to high-voltage power applied thereto. The super-high frequency of 2,450 MHz generated from the magnetron causes an electric field to change direction at a rate of 2.45 billion times per second. Where this super-high frequency is applied to food, molecules of water in the food vibrate at a rate of 2.45 billion times per second while generating a large amount of heat, thereby cooking the food.

One type of such a conventional microwave oven may be, for example, a wall-mounted microwave oven that is mounted above a gas range and functions as a hood for sucking vapor, fumes or smoke generated by cooking of food on the gas range, and for exhausting the smoke externally.

FIG. 1 shows the construction of a high-voltage control circuit of a conventional wall-mounted microwave oven. As shown in FIG. 1, the high-voltage control circuit of the conventional wall-mounted microwave 100 oven comprises a magnetron 105, a high-voltage transformer 110 boosting a voltage of commercial alternating current (AC) power 115 to a predetermined high voltage, and a high-voltage capacitor 120 and a high-voltage diode 125 cooperating to supply the high voltage boosted by the high-voltage transformer 110 to the magnetron 105. The magnetron 105 is driven in response to the high voltage supplied thereto to oscillate microwaves.

Power P available in the microwave oven is represented as the product of an input voltage V, input current I, and power-factor cos φ (P=VI cos φ). The power-factor is a numerical value expressing a ratio indicative of how effectively supply power works on load, which ratio is a ratio of effective power to apparent power in an AC circuit. The power-factor is typically indicated by percentages (%), and is 1 if a voltage/current phase angle is 0, namely, cos φ=1 if φ=0, resulting in the maximum real power. In other words, the power-factor is 1 at the highest power level and 0 at the lowest power level. In general terms, the power factor is 1 in an electric energy/thermal energy conversion device such as an electric heater or incandescent lamp, but it is degraded below 1 in a device, such as an electric motor or transformer, which has a core and is driven by magnetically stored energy from magnetic fluxes produced by current from an AC power source to the core.

In the microwave oven, higher output power requires higher input power. In this regard, the input voltage, input current or power-factor must be increased in order to raise output power of the microwave oven to a higher level.

However, electrical safety codes typically limit the fuse rating for a wall outlet to 15 amperes (A). In this connection, wall-mounted microwave ovens on sale in the U.S.A. are limited to 15A maximum current draw.

Since the current I and voltage V are limited to 15A and 120V, respectively, the power-factor cos φ must be 1 in order to maximize output power. However, any phase difference between the input current and the input voltage lowers the power factor below 1. In addition, other electrical components, such as, for example, the magnetron, can introduce additional inductance into the control circuit due to an inductive reactance component of the magnetron.

That is, as shown in FIG. 2, current 205 is later in phase than voltage 210 measured at the high-voltage transformer 110 of the microwave oven 100. As a result, the power-factor becomes lower than if the current 205 and voltage 210 are in phase with each other, resulting in a lower output power than the maximum available power.

### SUMMARY OF THE INVENTION

The present invention was conceived in view of the above problems. One aspect of the present invention is to provide a high-power control circuit of a microwave oven which is capable of aligning the phase of voltage and current in the microwave oven circuit to improve a power-factor in circuit, thereby raising output power of the oven to a maximum achievable level.

In accordance with the present invention, the above and/or other aspects of the invention can be accomplished by a high-power control circuit of a microwave oven including a high-voltage transformer boosting a voltage of commercial alternating current (AC) power to a predetermined high voltage, and a magnetron for oscillating microwaves in response to the high voltage from the high-voltage transformer, and a power-factor compensation unit that compensates a degradation in power-factor resulting from a voltage/current phase difference in the high-voltage transformer.

Additional aspects and advantages of the invention will be set forth in part in the description which follows and, in part, will be obvious from the description, or may be learned by practice of the invention.

### BRIEF DESCRIPTION OF THE DRAWINGS

These and other aspects and advantages of the invention will become apparent and more readily appreciated from the following description taken in conjunction with the accompanying drawings, in which:

FIG. 1 is a circuit diagram showing the construction of a high-voltage control circuit of a conventional microwave oven;

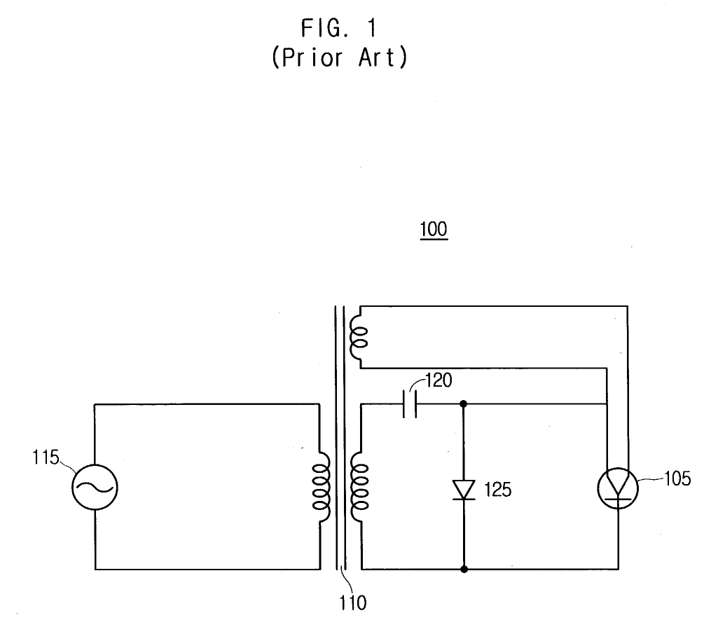

FIG. 2 is a graph showing waveforms of a voltage and current in FIG. 1;

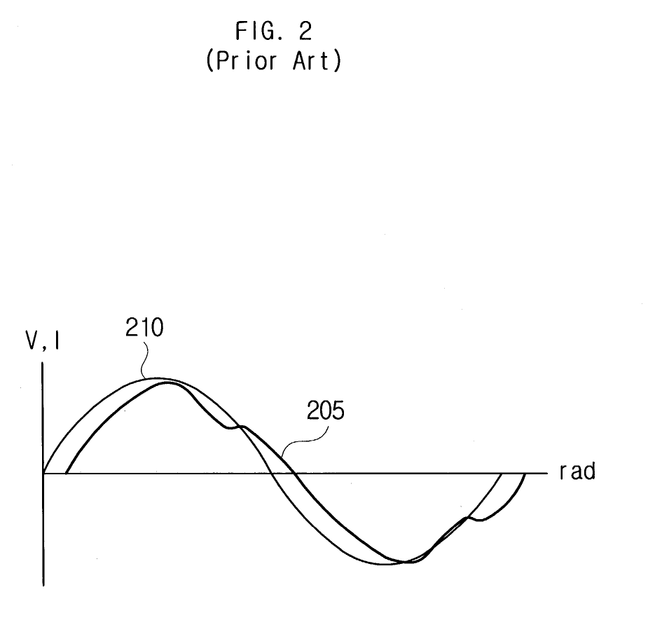

FIG. 3 is a circuit diagram showing the construction of a high-power control circuit of a microwave oven in accordance with the present invention;

FIG. 4 is a circuit diagram showing the construction of a high-power control circuit of a microwave oven in accordance with an alternative embodiment of the present invention; and

FIG. 5 is a graph showing waveforms of a voltage and current in the high-voltage transformer in FIG. 3 or 4.

### DETAILED DESCRIPTION OF THE PREFERRED EMBODIMENTS

A more detailed description of embodiments of the invention are provided below and are illustrated in the accompanying drawings. Like reference numerals refer to like elements described in the specification and shown in the figures.

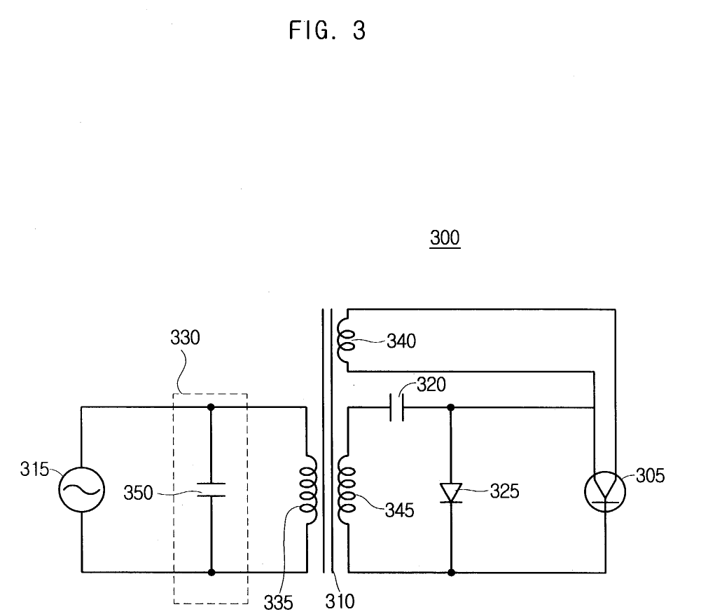

FIG. 3 shows the construction of a high-power control circuit 300 of a microwave oven in accordance with an embodiment of the present invention. As shown in FIG. 3, the high-power control circuit of the microwave oven comprises a magnetron 305, a high-voltage transformer 310 boosting the voltage of commercial AC power 315 to a predetermined high voltage, a power-factor compensator 330 compensating a voltage/current phase difference in the high-voltage transformer 310, and a high-voltage capacitor 320 and high-voltage diode 325 cooperating to supply the high voltage boosted by the high-voltage transformer 310 to the magnetron 305. The magnetron 305 is driven in response to the high voltage supplied thereto to oscillate microwaves.

The high-voltage transformer HVT has a primary coil 335 connected to the commercial AC power source 315 and secondary coils 340, 345 connected to a load stage. The secondary coil 345 supply s the high voltage to the magnetron 305 and the secondary coil 340 is a low voltage winding that provides current to a filament of the magnetron 305. The primary coil 335 and secondary coils 340, 345 are arranged to have a predetermined turn ratio.

The power-factor compensator 330 includes a capacitor 350 of a predetermined capacitance connected in parallel to both ends of the primary coil 335 of the high-voltage transformer 310. It is common to have a lagging current with a phase that is behind the voltage in an inductive load, such as, a coil, and a leading current having a phase that is ahead of the voltage in a capacitive load such as a capacitor. Other circuit elements, such as for example, the magnetron 305, also can introduce inductance into the circuit 300. In this regard, the power-factor compensator 330 offsets the phase difference in the primary coil of the high-voltage transformer 310 by causing a leading current to flow through the capacitor 330 and into the primary coil 335. Thus, the power-factor in the high-voltage transformer is improved by countering the lagging current with the leading current.

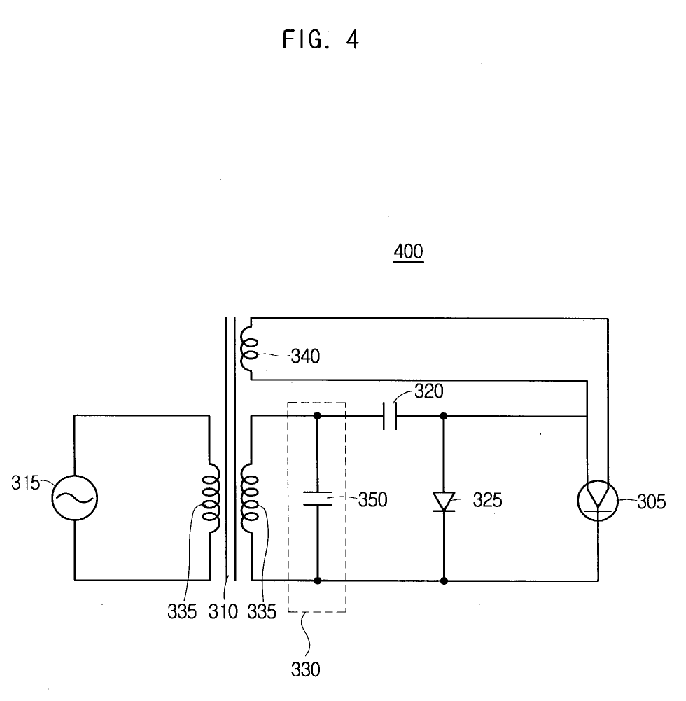

FIG. 4 is a circuit diagram showing the construction of a high-power control circuit 400 of a microwave oven in accordance with another embodiment of the present invention, wherein the power-factor compensator 330 in FIG. 3 is connected to the output of the high-voltage transformer 310. The power-factor compensator 330 includes the capacitor 350 connected in parallel to both ends of the secondary coil 345 of the high-voltage transformer 310. The power-factor compensator 330 offsets a phase difference in the secondary coil 345 of the high-voltage transformer 310 by a leading current that flows through the capacitor 350 and by introducing the leading current to the secondary coil 345. As a result, a power-factor in the high-voltage transformer 310 is improved in a similar manner to that described above.

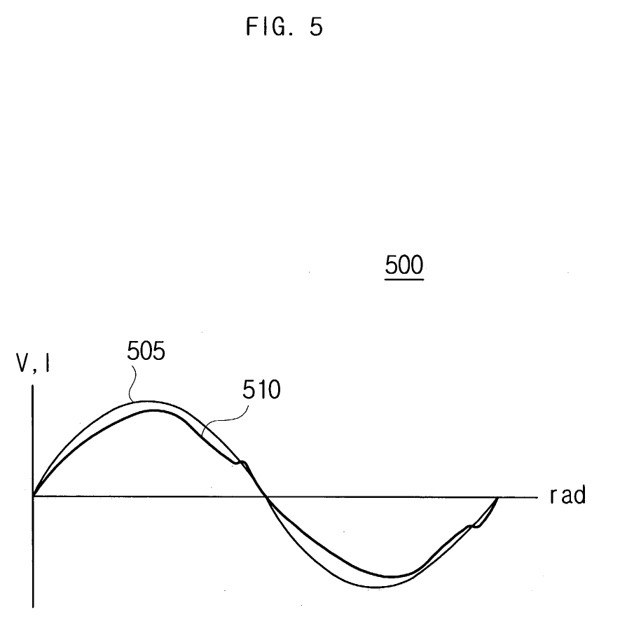

FIG. 5 is a graph 500 showing waveforms of voltage 505 and current 510 in the high-voltage transformer 310 in FIG. 3 or 4. The phase alignment of the voltage 505 and the current 510 of the primary 335 or secondary coil 345 of the high-voltage transformer 310 is improved by the leading current from the capacitor 350, thereby enabling output power of the microwave oven to be raised to a higher level.

As apparent from the above description, the present invention provides a high-power control circuit of a microwave oven which is capable of improving a power-factor in the circuit, so as to raise output power of the microwave oven to a higher level under the same voltage/current conditions.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A high-power control circuit of a microwave oven, comprising:
a high-voltage transformer boosting a voltage of commercial alternating current (AC) power;
a magnetron oscillating microwaves in response to the high voltage from said high-voltage transformer; and
a power-factor compensation unit compensating a degradation in power-factor resulting from a phase difference between voltage and current in said high-voltage transformer.

2. The high-power control circuit as set forth in claim 1, wherein said power-factor compensation unit includes a capacitor supplying a leading current to said high-voltage transformer to compensate for said phase difference, said leading current having a phase being ahead of that of the voltage in said high-voltage transformer.

3. The high-power control circuit as set forth in claim 2, wherein said capacitor is connected in parallel to an input of said high-voltage transformer.

4. The high-power control circuit as set forth in claim 3, wherein said capacitor is connected in parallel to both ends of a primary coil of said high-voltage transformer.

5. The high-power control circuit as set forth in claim 2, wherein said capacitor is connected in parallel to an output of said high-voltage transformer.

6. A microwave circuit, comprising:
a high-voltage transformer having a primary coil and a secondary coil, the primary coil being connectable to an alternating current power source;
a magnetron connected to the secondary coil;
a power correction unit connected to the microwave circuit being operable to correct a lagging power factor in the microwave circuit.

7. The microwave circuit of claim 6, wherein the power correction unit comprises a reactive element being operable to correct the lagging power factor.

8. The microwave circuit of claim 7, wherein the high-voltage transformer causes the lagging power factor.

9. The microwave circuit of claim 7, wherein the magnetron contributes to the lagging power factor.

10. The microwave circuit of claim 6, wherein the power correction unit includes a first capacitor.

11. The microwave circuit of claim 10, wherein the first capacitor is connected in parallel across the primary coil.

12. The microwave circuit of claim 10, wherein the first capacitor is connected in parallel across the secondary coil.

13. The microwave circuit of claim 10, further comprising:
a second capacitor having a first lead and a second lead, the first lead being connected to the secondary coil and the second lead connected to the magnetron such that the second capacitor provide a series connection between the secondary coil and the magnetron; and
a diode having a first lead connected at a same electrical node as the connection between the second lead of the second capacitor and the magnetron, the diode being connected in parallel with the magnetron.

14. The microwave circuit of claim, wherein:
the high voltage transformer further comprises a low voltage winding having a first low voltage lead and a second low voltage lead;
the magnetron comprises a first filament lead and a second filament lead; and
wherein:
the first filament lead is connected to the second lead of the second capacitor and the first low voltage lead; and
the second filament lead is connected to the second low voltage lead.

15. A method of increasing output power in a microwave circuit, comprising:
boosting a voltage from an alternating current power source to provide high voltage to a magnetron; and
correcting a power factor of the microwave circuit by minimizing a phase difference between voltage and current in the microwave circuit.

16. The method of claim 15, wherein the current lags the high voltage resulting in a lagging power factor and the correcting comprises correcting the lagging power factor.

17. The method of claim 15, wherein the microwave circuit includes a capacitor and the correcting comprises:
correcting the power factor with the capacitor.

18. The method of claim 15, wherein a primary coil of a high-voltage transformer is connected to an alternating current power source and a secondary coil of the high voltage transformer is connected to a magnetron in the microwave circuit wherein:
the boosting the voltage comprises stepping up a voltage with the high-voltage transformer includes; and
the correcting comprises correcting a lagging current caused by the high-voltage transformer.
